(19) United States
(12) Patent Application Publication
(10) Pub. No.: US 2002/0013796 A1
(43) Pub. Date: Jan. 31, 2002

(54) Method of processing data

(76) Inventors: Michael Byrne, Navan (IE); Thomas Moore, Rathmines (IE)

Correspondence Address: BIRCH STEWART KOLASCH & BIRCH, PO BOX 747, FALLS CHURCH, VA, 22040-0747, US

(21) Appl. No.: 09/900,145

(22) Filed: Jul. 9, 2001

(30) Foreign Application Priority Data
Jul. 28, 2000 (IE) S2000\0603
Jan. 8, 2001 (IE) PCT/IE01/00002

(51) Int. Cl. G06F 7/00

(52) U.S. Cl. 708/200; 712/223

(57) ABSTRACT

A method of processing two data words to provide a new data word in a processor, as well as a processor to perform such a method, comprising an arithmetic logic unit, a plurality of registers and access to memory characterised in that the method comprises, not necessarily in this order, the steps of using the ALU to perform an operation on the data words to form another data word and performing a switching operation on one of the data words. Both of the above steps are completed by executing a single instruction. The instruction may be completed in one clock cycle thereby improving the performance of the processor. Such switching operations may be performed by using either hard wiring techniques or logic gate circuitry.

### BACKGROUND OF INVENTION

1. Field of Invention

This invention relates to data processors and to a method of improving the processing speed of data processors and in particular to a method of processing two data words to provide a new data word in a processor comprising an arithmetic logic unit (ALU), a plurality of registers and access to memory.

Increasingly, designers are looking for new ways to improve the processing speed of data processors and to decrease the time it takes to execute instructions and programs. Considerable strides have been made in improving the processor speed itself which has helped to increase the processing speed, but increasingly the individual instructions and the tasks to be performed by the processor are becoming more relevant to the delays experienced by the processor.

In general, data processors container an arithmetic logic unit (ALU), a plurality of registers having data words stored therein and access to memory. The ALU performs a variety of different arithmetic or logical operations on pairs of data words. These operations may include addition, subtraction, logical AND, OR, XOR, NAND, NOR and XNOR instructions. Quite often, several of these instructions will have to be completed in succession. Therefore, the time spent completing an operation of this type can be critical to overall processing speed. Furthermore, it has been found that certain applications do not require the use of an entire data word, but only the top or bottom half of such a data word. Often, it may be the case that the top half of one data word is to be computed with the bottom half of another data word. This has been found to be the case particularly in the field of communications and networks. For instance, in a network situations the processor may be in an application processing packets of data received from an Ethernet local area network (LAN). These packets of data contain addresses and further data and are often larger than the registers into which they are being placed. If, for instance, the length of an address is one and a half times the register width and there are contiguous registers with all bits used, then three registers would be required to store two addresses. The first address received would be put into a first register with the remainder placed in the top half of a second register and a second address received would be put into the bottom half of the second register and the remainder of the second address would fill a third register. It is clear then that to complete any calculations on either of the addresses, only half of the second register is required. The rest of the data in that register is surplus to requirements.

Up until now, there have been two known ways of handling such a situation, namely to perform either a logical shift operation or a rotational shift operation followed by an operation to manipulate the data in some desired way. In the logical shift operation, the entire piece of data is shifted a required number of bit positions in either a left or a right direction, depending on which piece of data is desired. Depending on the processing power available, the entire block of data may be shifted the required number of bits in one clock cycle or it may be necessary to shift the bits one bit position at a time. The latter situation is disadvantageous In that in order to position the data correctly, a large number of these shift operations have to be completed. For instance with a 34 bit piece of data where it is required to perform a logical operation on the top half (bits 33 to 17) of the data with the bottom half (bits 16 to 0) of another word, then in order to align the two relevant bits of data, one piece of data will have to be shifted 17 times. This is before any operation on the two pieces of data can be carried out. This will take 17 clock cycles to complete which is unacceptable. In the former case, if the processing capability is at hand, then the entire block of data may be shifted in one cycle but then another instruction in another clock cycle is required to carry out any further operation on the data, slowing the processor down. Another disadvantage is that the data shifted out of the register will be lost unless the entire data word has been written to memory previously. All of this delays the processing of an application and reduces the processing speed of a processor significantly.

Another known way of achieving the correct alignment of the bit positions in the data words is to perform a series of rotational shift operations. In this type of operation, a bit is taken from one end of the date word, the remainder of the bits are shifted in the direction of the now empty bit position and the original bit is appended to the opposite end of the word from which it came. For instance, in a rotational shift left, the most significant bit (MSB) is removed, the remaining bits are all shifted left by one bit position and the MSB is then placed in the now vacant least significant bit (LSB) position. Again, depending on the processing power at hand, for a 34 bit data word, this may have to be performed 17 times in order to swap the upper and lower halves of a data word before an operation could even be carried out on the data. This is extremely time consuming for the processor as each shift operation takes an entire clock cycle to complete. Once a number of these instructions have to be completed, the overall processing speed may be reduced significantly, While with superior processing ability at hand, all the rotation shift operations could be achieved in one cycle this would have to be followed by an arithmetic or logical operation between the relevant pieces of data themselves. This is inefficient coding practice as well as an inefficient use of processor time.

### OBJECTS OF THE INVENTION

The present invention is directed towards providing a processor which would be able to execute a single instruction that would complete all the necessary shift operations and any arithmetic or logic operations in a single clock cycle. This would result in a more efficient method of processing data as well as creating a more efficient data processor.

### SUMMARY OF THE INVENTION

According to the invention, there is provided a method for processing two data word s to provide a new data word in a processor comprising an arithmetic logic unit (ALU), a plurality of registers and access to memory characterised in that the method comprises, not necessarily in this order, the steps of:

(a) using the ALU to perform an operation on data words, each being of n-bit size, to form another data word of n-bit size; and

(b) performing a switching operation on one of the data words

The advantages of such a method are numerous. Firstly, we have a single instruction which can carry out a number of tasks whereas before, the same command would have taken at least two, if not more, instructions to carry out. Secondly, the fact that the instruction can now be carried out in a single clock cycle shortens the task execution time and reduces power consumption both of which are becoming more important nowadays The steps mentioned can be performed in either order, depending on the type of calculation to be made or data required, as well as where the data is to be located in a register once the calculation has been completed. It may be that the data must be switched before an ALU operation is performed due to the required data being in the wrong position in the data word. Alternatively, it may be necessary to position the data in a particular manner in a register once all the calculations have been completed. This also is possible by using the above mentioned method.

In another embodiment of the invention, the switching operation further comprises the steps of:

(c) separating the data word into an upper portion and a lower portion;

(d) generating a mirror data word of p-bit size, where p=n;

(e) separating the mirror data word into an upper portion and a lower portion where the upper portion of the mirror data word is equal in size to the lower portion of the data word and the lower portion of the mirror data word is equal in size to the upper portion of the data word;

(f) copying the data in the upper portion of the data word into the lower portion of the mirror data word and copying the data in the lower portion of the data word into the upper portion of the mirror data word; and

(g) substituting the data word With the mirror data word.

The upper and lower bit portions may be formed to be as close to equal if not equal in size as is possible. Alternatively, if a specific number of bits is required, then this also may be defined. The number of bits to be repositioned could depend largely on the field of application of the data processor and the various types of operations that must be performed by it, it can be seen that the above method, by simultaneously writing all the bits in both portions of the data words to the relevant portions of the mirror data word and performing an operation on the data word at the same time, significantly reduces the time taken to execute an instruction.

In another embodiment of the invention, when n is an even number, the data word's upper portion comprises bit (n−1) to bit (n/2) and it's lower portion comprises bit [(n/2)−1] to bit 0 and the mirror data word's upper portion comprises bit (p−1) to bit (p/2) and it's lower portion comprises bit [(p/2)−1] to bit 0. Often, it will be the case that the data word will have an even number of bits. In many applications such as the network application already described, one half of the data in a particular data word will be required. The above method enables operations to be carried out on both halves of the data word in an efficient manner with a minimum of difficulty.

In another embodiment of the invention, when n is an uneven number, the data word's upper portion comprises bit (n−1) to bit [(n−1)/2] and its lower portion comprises bit {[(n−1)/2]−1} to bit 0 and the mirror data word's upper portion comprises bit (p−1) to bit [(p+1)/2] and it's lower portion comprises bit [(p−1)/2] to bit 0. When processing data of uneven bit size, the processor designates the upper portion of the data word as the larger of the two portions. The lower portion of the mirror data word is designated as the larger portion for reception of this data word upper portion. Similarly, the lower portion of the data word and the upper portion of the mirror data word are assigned the same number of bits. Alternatively, if desired, the lower portion of the data word and the upper portion of the mirror data word may be designated as the larger portion while the upper portion of the data word and the lower portion of the mirror data word are designated as the smaller portions. This choice will be entirely up to the designer and may be determined by the type of calculations that will be performed. This is one way of handling uneven size data.

In a still further embodiment of the invention, when n is an uneven number, subsequent to generating a mirror data word of p-bit size where p=n, the additional intermediate step is performed of:

(h) designating a particular bit of the data word to act as a static bit, writing the static bit to the corresponding position in the mirror data word and thereafter performing the separation and copying steps on the remainder of the bits of the data word and the mirror data word.

By this, we are essentially writing one bit of an uneven data word directly to the mirror data word and thereafter performing the switching operation on the remainder of the data which now consists of an even number of bits. This static bit may preferably be the MSB, LSB or the central bit [(n−1)/2]. It may, In fact, be any chosen bit of the data word. This is another way in which uneven bit size data may be handled.

In another particularly preferred embodiment of the invention, the switching operation performed on one of the data words is performed by using cross wiring techniques. This is seen as a most advantageous method of performing the invention. By hardwiring the bits, the bits are switched automatically and practically instantaneously which negates the need for several instructions to be carried out and also reduces the processing time used to carry out that portion of the instruction. There is no extra logic required to perform the switching of the portions of the data word. The data flows along a wiring path that has been cross-wired and is switched as it flows along that path.

In another embodiment of the invention, the switching operation is performed on one of the data words using logic circuitry. The logic circuitry in effect will perform the identical operation of the switching of the bits in the data word but will do so by performing a rotational shift operation on the data. The result will be either the final result of the instruction or may be used for further processing but again it may all be achieved by a single instruction.

In a still further embodiment of the invention, the switching operation is performed on one of the data words before an ALU operation is performed on that data word an another data word. Depending on the data required, it may be desirable to switch the data of a word before an ALU operation is performed on it with another operand. This type of instruction is called an X-type instruction. For instance, if the data required is in the top half of the operand that is to be operated on with a piece of data in the lower half of another operand, then we would perform a switching operation on the first operand to swap the upper and lower portions so that an operation could then be performed on the correctly aligned data words. Alternatively, it may be desirable to perform an operation on two data words and then perform a switching operation on the result. This type of instruction is called an S-type instruction. This may be to correctly align the data for further processing or for presentation of the data in a particular manner. The bitwise operations that these type of operations involve are AND, NAND, OR, NOR, XOR, XNOR. ADD and SUB resulting in ANDX, NANDX, ORX, NORX, XORX, XNORX, ADDX, SUBX, ANDS, NANDS, ORS, NORS, XORS, XNORS, ADDS and SUBS instructions. For example, an ANDS instruction would entail bitwise AND-ing two data words together followed by switching the upper and lower portions of the resulting data word.

In another embodiment of the invention, there is provided a method of processing two data words to provide a new data word in a processor comprising an ALU, a plurality of registers and access to memory characterised in that the method comprises, not necessarily in this order, the steps of:

(a) using the ALU to perform an operation on the data words each being of n-bit size, to form another data word of n-bit size;

(b) performing a switching operation on one of the data words in which the data word is separated into discrete portions and the order of the portions is rearranged by using cross-wiring techniques, the cross-wiring techniques further comprising the step of:

(c) delivering the data word from a start location to an end location along a pathway in which the wires of the pathway have been cross-wired so that the individual bits of the data word may be rearranged into a desired configuration before arriving at the end location.

The advantage of this above method is that the individual bits of the data word are switched as they are in transit to their destination and are not stored in any intermediate storage medium. By doing so, the switching operation is performed practically instantaneously and a logical operation or arithmetic operation may be performed in the same clock cycle. The ALU operation may be performed after the switching operation in which case the end location of the data word is the ALU. Alternatively, the ALU operation may be performed before the switching operation in which case the start location of the data word is the result of the ALU operation. By cross-wiring the bits in this manner, the invention may be carried out most efficiently. It is seen as a preferred way of carrying out the invention.

In a further embodiment still, there is provided a method of processing two data words, each having a plurality of bits, to provide a new data word in a processor, the processor comprising an ALU, a plurality of registers and access to memory characterised in that the method comprises the steps of:

(a) retrieving the data words from the registers;

(b) passing one of the data words directly to the ALU;

(c) passing the other data word to the ALU along a cross-wired pathway in which the individual bits of the data word may be rearranged into a desired configuration before arriving at the ALU; and

(d) performing an ALU operation on the two data words.

In this method, the data word is transmitted along a cross-wired pathway and is switched practically instantaneously before having an ALU operation performed on it Uneven bit numbers as well as even may be handled in this way.

In a further embodiment still, there is provided a method of processing two data words to provide a new data word in a processor, the processor comprising an ALU, a plurality of registers and access to memory characterised in that the method comprises the steps of:

(a) retrieving the data words from the registers;

(b) passing the data words to the ALU and performing an ALU operation thereupon;

(c) delivering the result of the ALU operation to a desired location along a cross-wired path in which the individual bits of the data ward may be rearranged into a desired configuration before reaching the desired location.

Again, the data word travels along a cross-wired pathway, this time on its way to its final destination once an ALU operation has been performed on it. This may be to a register or memory or onwards for use in further calculations. Both even and uneven bit size data words may be handled by this method. Again a particular bit may be chosen to act as a static bit and may be copied directly to the corresponding bit position in the end location. Again, by using a cross-wired pathway, the invention is carried out in a preferred manner.

In another embodiment of the invention, there is provided a data processor comprising an ALU, a plurality of registers and access to memory characterised in that the data processor comprises means to execute an instruction on two data words to provide a new data word, the means to execute an instruction comprising:

(a) means to perform an ALU operation on data words, each being of n-bit size, to form another data word of n-bit size; and

(b) means to perform a switching operation on one of the data words.

It has been found that this is a particularly efficient way of handling data in a data processor. The benefits that arise to the processor is the reduced time in which it must be involved on what is now essentially a single instruction whereas before it would have had at least two instructions to execute the program code required in such a processor will be shorter thus reducing the program storage space required. Therefore, what is produced is a more efficient processor that has the ability to execute tasks quicker than before. Furthermore, the power consumption of the processor is reduced which is invaluable for designers of processors and electronic circuits in general.

In another embodiment of the invention, the means to perform the switching operation further comprises:

(c) means to separate the data word into an upper portion and a lower portion:

(d) means to generate a mirror data word of p-bit size, where p=n;

(e) means to separate the mirror data word into an upper portion and a lower portion where the upper portion of the mirror data word is equal in size to the lower portion of the data word and the lower portion of the mirror data word is equal in size to the upper portion of the data word;

(f) means to copy the data in the upper portion of the data word into the lower portion of the mirror data word and write the data in the lower portion of the data word into the upper portion of the mirror data word; and

(g) means to substitute the data word with the mirror data word.

The upper and lower bit portions may be formed to be as close to equal to, if not equal, as possible. If a particular number of bits is required to be switched, this may also be achieved. By switching the bits and performing an operation in this way, the processor can significantly decrease the time taken to run through a particular program.

In a still further embodiment of the invention, there is provided a data processor in which when n is an even number, the data word's upper portion comprises bit (n−1) to bit (n/2) and it's lower portion comprises bit [(n/2)−1] to bit 0 and the mirror data word's upper portion comprises bit (p−1) to bit (p/2) and it's lower portion comprises bit [(p/2)−1] to bit 0. This is a common scenario in which we would have a processor processing data words of even bit size. As has already been explained, in certain applications such as communications, it may be desirable to use half of the data word. This may be done on a processor executing such an instruction as described.

In a still further embodiment of the invention, there is provided a data processor in which when n is an uneven number, the data word's upper portion comprises bit (n−1) to bit [(n−1)/2] and it's lower portion comprises bit {[(n−1)/2]−1} to bit 0 and the mirror data word's upper portion comprises bit (p−1) to bit [(p+1)/2] and it's lower portion comprises bit [(p−1)/2] to bit 0. It can be seen that the processor may be processing words of uneven bit number. If this is the case, then the processor may designate the upper portion of the data word and the lower portion of the mirror data word as the larger portions and the lower portion of the data word and the upper portion of the mirror data word as the smaller portions before any switching is carried out it is envisaged that the larger portions will be 1 bit larger in size than the smaller portions, although this may be chosen, depending on the number of bits required by that particular operation. Alternatively, the lower portion of the data word and the upper portion of the mirror data word may be designated as the larger portions, with the upper portion of the data word and the lower portion of the mirror data word as the smaller portions. This again will largely depend on the data required by a particular operation. This is one way In which the processor may handle uneven bit size data

In another embodiment of the invention, there is provided a data processor in which when n is an uneven number, subsequent to the generation of a mirror data word of p-bit size where p=n, the data processor further comprises:

(h) means to designate a particular bit of the data word to act as a static bit and to write the static bit to the corresponding position in the mirror data word; and thereafter performing the separation and copying steps on the remainder of the bits of the data word and the mirror data word.

By providing such a processor, the static bit is written directly and then essentially is ignored for the rest of the switching process. The remaining bits are switched as if they were an even bit data word. This static bit may be the MSB, LSB or the central bit [(n−1)/2]. In fact, it may be any chosen bit. This is another way in which the processor may handle uneven bit size data.

In a still further embodiment of the invention, there is provided a data processor in which the means to perform the switching operation on one of the data words comprises cross-wiring techniques. By using cross wiring techniques, the word may be switched almost instantaneously allowing for further operations to be carried out within the same clock cycle and by using a single instruction, it reduces the number of instructions necessary as well as significantly speeding up the operation. There is no extra logic required to perform the switching of the portions of the data word. The data flows along a wiring pathway that has been cross-wired and it is switched as it flows along that path. This is seen as particularly advantageous.

In another embodiment of the invention, there is provided a data processor in which the means to perform the switching operation on one of the data words comprises logic circuitry. By using logic circuitry, the switching operation may be performed by a rotational shift operation. This may require more circuitry than in the hardwiring case and essentially the same operation of switching around the bits of the data word is performed. Again, it has the advantage of being executable by a single instruction.

In a still further embodiment of the invention, there is provided a processor in which the switching operation is performed on one of the data words before an ALU operation is performed on that data word and another data word. It may be necessary for the processor to perform the switching operation on one of the data words prior to carrying out an ALU operation on the data words. This type of instruction is called an X-type instruction. Alternatively, the processor may be required to perform an ALU operation on the two data words before a switching operation is performed on the result of the ALU operation. This type of operation is called an S-type instruction. The bitwise operations that these type of operations involve are AND, NAND, OR, NOR, XOR, XNOR, ADD and SUB resulting in ANDX, NANDX, ORX, NORX, XORX, XNORX, ADDX, SUBX, ANDS, NANDS, ORS, NORS, XORS, XNORS, ADDS and SUBS instructions. For example, an ANDS instruction would entail logical AND-ing two data words together followed by switching the upper and lower portions of the resulting data word.

In another embodiment of the invention there is provided a data processor comprising an ALU, a plurality of registers and access to memory characterised in that the data processor comprises means to execute an instruction on two data words to provide a new data word, the means to execute an instruction comprising:

(a) means to perform an ALU operation on the data words, each being of n-bit size to form another data word also of n-bit size:

(b) means to perform a switching operation on one of the data words in which the data word is separated into discrete portions and the order of the portions is rearranged by cross-wiring means, the cross-wiring means comprising:

(c) a wiring pathway between a start location and an end location in which the wires of the pathway have been cross-wired so that the individual bits of the data word may be rearranged into a desired configuration before arriving at the end location.

A process of this type has the ability to perform the switching operation and the ALU operation in the same clock cycle. A data word travelling down the cross-wired pathway will be automatically rearranged into the desired configuration when it arrives at its destination. This negates the need for two separate instructions Furthermore, the end location of the wiring pathway may be at the input of the means to perform an ALU operation in which case the data word is switched before the ALU operation or alternatively the start location of the wiring pathway may be at the end location of the means to perform an ALU operation in which case the ALU operation is carried out before a switching operation. It is seen as preferred to cross-wire the pathway in this manner.

In a still further embodiment of the invention, there is provided a data processor comprising an ALU, a plurality of registers and access to memory characterised in that the data processor comprises means to execute an instruction on two data words to provide a new data word, the means to execute an instruction comprising:

(a) means to retrieve the data words from the registers;

(b) means to pass one of the data words directly to the ALU;

(c) means to deliver the other data word to the ALU along a cross-wired pathway in which the individual bits of the data word may be rearranged into a desired configuration before arriving at the ALU; and

(d) means to perform an ALU operation on the two data words.

This will allow both the switching operation and the ALU operation to be carried out in one clock cycle in the processor.

In another embodiment of the invention, there is provided a data processor comprising an ALU, a plurality of registers and access to memory characterised in that the data processor comprises means to execute an instruction on two data words to provide a new data word, the means to execute an instruction comprising:

(a) means to retrieve the data words from the registers;

(b) means to perform an ALU operation on the data words to produce a result data word;

(c) means to deliver the result data word to a desired location along a cross-wired path in which the individual bits of the result data word may be rearranged into a desired configuration before reaching the desired location.

This processor will enable us to perform a switching operation subsequent to an ALU operation, both of which may be completed in the same clock cycle. Again, the cross-wiring of the pathway between the output of the ALU and the end destination is seen as a beneficial way of carrying out the invention.

In another embodiment of the invention, the processor essentially comprises a design of a processor that is embodied in a computer program. This program may be stored on a computer readable medium. This may include a floppy disks CD-ROM or other similar record medium. Alternatively, the computer program may be stored on a carrier signal. This may be either an electrical or an optical or a radio frequency carrier signal.

In another embodiment of the invention, there is provided a computer program comprising program instructions for causing a computer to perform the method of the invention. In this embodiment it must be understood that essentially what we would have is a program code from which a processor will run. Alternatively, we could have a design of a processor that would be programmed to carry out the invention before it has been realised in silicon. These programs may be stored on a record medium such as a computer readable medium. This computer readable medium may be any of CD, floppy disk, DVD or the like. The computer program may be embodied in ROM or embedded on an integrated circuit.

In another embodiment of the invention, there is provided a computer program stored on a carrier signal, This carrier signal may be an electrical carrier signal or an optical carrier signal or other type for transmitting signals across the internet.

In a still further embodiment of the invention, there is provided a computer programmed to carry out the method of processing two data words to provide a new data word. The computer itself may have software loaded thereon which will enable it to carry out the method as outlined above.

### BRIEF DESCRIPTION OF THE DRAWINGS

The invention Will be more clearly understood from the following description of some embodiments thereof, given by way of example only, with reference to the accompanying drawings, in which:

FIG. 1 is a block diagram of the processor according to the invention;

FIG. 2 is a flow diagram illustrating a method according to the invention;

FIG. 3 is a block diagram of part of the method outlined in FIG. 2 showing an X instruction;

FIG. 4 is a block diagram of part of the method outlined in FIG. 2 showing an S instruction;

FIG. 5 is a flow diagram illustrating an alternative method according to the invention;

FIG. 6 is a block diagram illustrating the method of FIG. 5;

FIG. 7 is a block diagram illustrating switching using hardwiring;

FIG. 8 is a block diagram illustrating a rotational shift operation; and

### DETAILED DESCRIPTION OF THE EMBODIMENTS

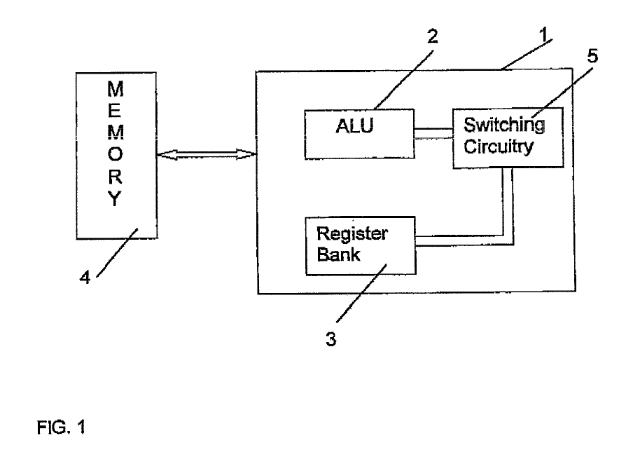

Referring to the drawings and in particular to FIG. 1, there is illustrated a block diagram of a processor according to the invention. The processor, indicated generally by the reference numeral 1, comprises an ALU 2, a plurality of registers 3 and access to memory 4. The processor is arranged to execute an instruction on two data words to provide a new data word according to the methods hereinafter described. Furthermore, there is shown the switching circuitry 5. This is to provide the separation and the copying of one of the data words to a mirror data word which will be discussed in detail below.

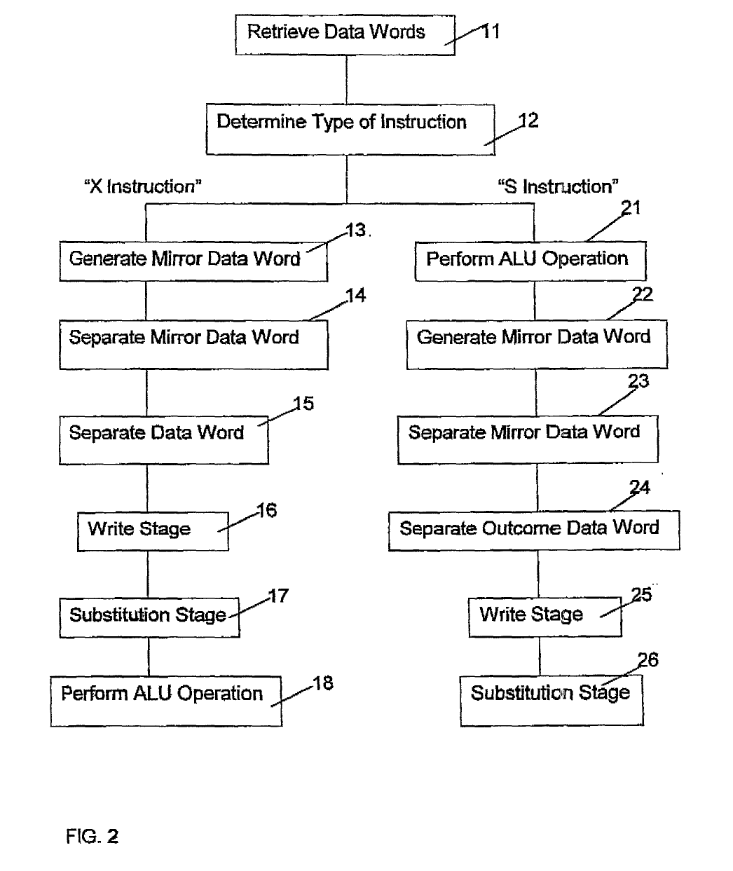

Referring now to FIG. 2, there is illustrated a flow diagram of a method of processing two data words to provide a new data word. In step 11, a pair of data words of size n-`bits are retrieved. These may have been retrieved from memory or from the registers or indeed from both the memory and the registers. At step 12, the processor determines the type of instruction to be executed, namely, whether it has received an X instruction or an S instruction. If an X instruction has been given, the method will proceed to step 13 where a mirror data word is generated. The mirror data word is of p-bit size, where p=n. Again, as already explained, this mirror data word is not necessarily generated every time the instruction is executed. More than likely, it will be a permanent wiring in hardware in which case the wires of the data word are cross-wired and connected directly to the ALU and the data word is switched as it passes along the wiring. This means that the mirror data word would in fact be a virtual data word and is created by the data flowing along the wiring. At step 14, the mirror data word is separated into an upper portion and a lower portion. At step 15, one of the data words is separated into an upper portion and a lower portion. When the number of bits n of a data word is even, then it may be desirable to divide n into two equal halves. When the number of bits n of a data word is uneven, then it may be desirable to have the two portions as close to equal as possible, having one portion of the data word one bit larger than the other portion. The choice as to which will be the larger portion will be up to the designer and the data that is required by him. Alternatively, the designer may require a specific number of bits and may select the size of the portions accordingly. The main thing is that the portions of the data word and the mirror data word are always separated in such a way that the upper portion of the data word is equal in size to the lower portion of the mirror data word and the lower portion of the data word is equal in size to the upper portion of the mirror data word. At step 16, the write stage, the upper portion of the data word is written to the lower portion of the mirror data word and the lower portion of the data word is written to the upper portion of the mirror data word. At step 17, the mirror data word is substituted for the data word. Of course, by substitution, It does not necessarily mean that the entire data word is overwritten by the mirror data word. It may be that the mirror data word will replace the data word or be used instead of it in a further calculation. At step 18, an ALU operation is performed on the other original data word and the switched data word to form a new data word. By using this method, both the switching operation and the ALU operation are completed in the same clock cycle by one instruction.

If, at step 12, the processor determines that an S instruction is to be carried out, then the method will proceed to step 21 where an ALU operation is performed on the data words to produce another data word. Again, this ALU operation may comprise an AND, NAND, OR, NOR, XOR, XNOR, ADD or SUB instruction. In step 22, a mirror data word is generated and in step 23, the mirror data word is separated into an upper portion and a lower portion. In step 24, the data word created as a result of the ALU operation, the outcome data word, is separated into an upper portion and a lower portion. In step 25, the upper portion of the outcome data word is written to the lower portion of the mirror data word and the lower portion of the outcome data word is written to the upper portion of the mirror data word. Finally, in step 26, the mirror data word is substituted for the outcome data word. Again, by substitution, we do not necessarily mean the entire re-writing of the word but we can simply mean that the now switched form of the outcome data word rather than the outcome data word, will be the result of the instruction and will be used in any future stored memories or further calculations. This is achieved by cross-wiring the result of the ALU to the end destination of the data word.

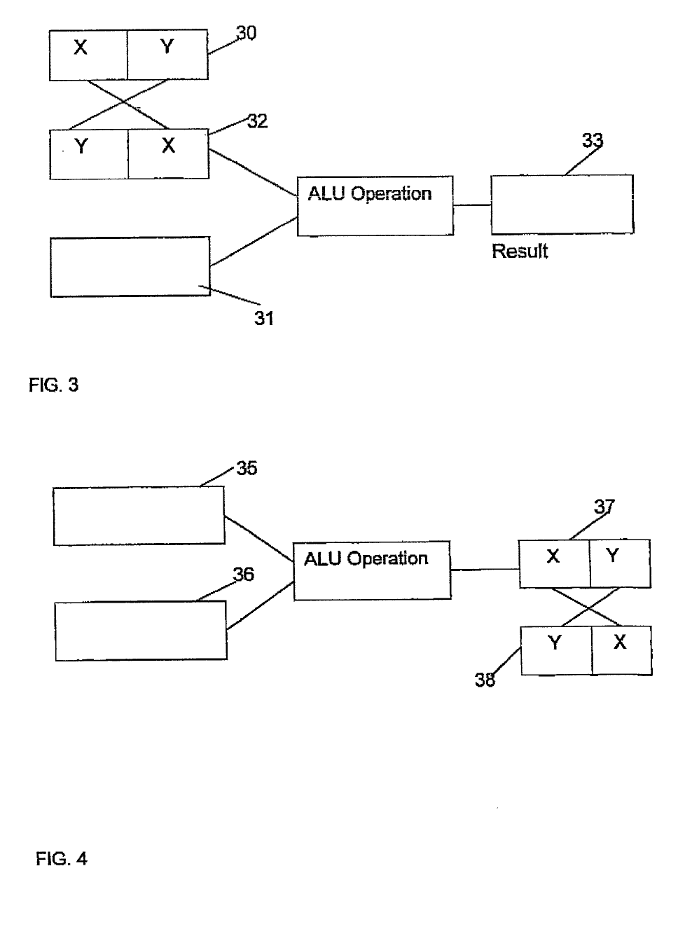

Referring now to FIGS. 3 and 4, there are shown in block diagram form an X instruction and an S instruction respectively. As can be seen, in FIG. 3, two data words 30 and 31 are to be operated on. Before the operation, a mirror data word 32 is generated, the upper portion of the data word 30 is written to the lower portion of the mirror data word 32 and the lower portion of the data word 30 is written to the upper portion of the mirror data word 32. The mirror data word is substituted for the data word and an ALU operation is carried out on the mirror data word 32 and the data word 31 producing a result data word 33. Alternatively, the data word 30 may be cross-wired directly to the ALU so that the mirror data word is seen as a virtual data word on the hardwiring. The data word is automatically switched as it travels along the wiring to the ALU. Again, in FIG. 4, for an S instruction, an ALU operation is performed on two data words 35, 36 producing an outcome data word 37. A mirror data word 38 of this outcome data word 31 is then generated and the relevant separation and writing stages are carried out on the outcome data word 37 and the mirror data word 38. Finally, the mirror data word 38 is substituted for the outcome data word 37 as the result of the instruction. Alternatively, the mirror data word may be the end location of the switched result of the ALU and the data word is switched by passing along a cross-wired pathway en route to the end destination of the data.

The upper and lower portions of both the data word and mirror data word may be equal in size if the number of bits n of the data word is an even number. If n is an uneven number, then one portion will be larger than the other portion in a data word. The choice of which is the larger portion is up to the programmer and will be dictated largely by the data that is required for a particular operation. The important thing is that if the upper portion of the data word is chosen to be the larger portion, then the lower portion of the mirror data word must also be chosen as the larger portion and vice versa.

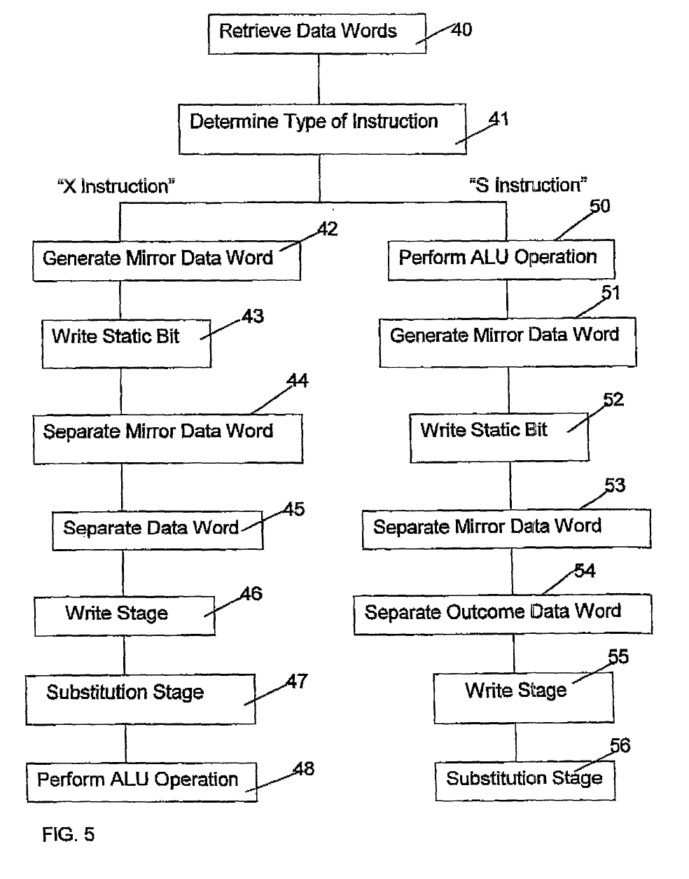

Referring now to FIG. 5, there is shown a flow diagram illustrating an alternative method according to the invention. In this method, a different approach may be taken to uneven bit size data words. Under the previous method, the upper and lower portions of the data word were selected so that they were as near to even as possible. This still meant that uneven bit numbers were being swapped in the writing stage which may not be ideal. In step 40, the data words are retrieved in the usual manner. In step 41, the processor determines whether an X or S instruction is to be carried out. If an X instruction is to be carried out, the method proceeds to step 42 where a mirror data word is generated. In step 43, a bit that has been preselected as a static bit is written from the data word to the corresponding bit position in the mirror data word. The static bit may be any chosen bit but preferably one of either the MSB, LSB or central bit will be chosen. In step 44, the remainder of the mirror data word, excluding the static bit is separated into an upper portion and a lower portion. In step 45, the remainder of the data word, excluding the static bit is separated into an upper portion and a lower portion. Ideally, both the upper and lower portions are the same size but this need not be the case, as described above. The upper portion of the data word must be the same size as the lower portion of the mirror data word and the lower portion of the data word must be the same size as the upper portion of the mirror data word.

In step 46, the upper portion of the data word is written to the lower portion of the mirror data word and the lower portion of the data word is written to the upper portion of the mirror data word. In step 47, the mirror data word is substituted for the data word for the reasons already described and in step 48, an ALU operation is performed on the original data word and the other now switched data word to form a new data word. Again, with this method, both the switching and ALU operations can be performed using a single instruction which is of great benefit

It at step 41, the processor is to perform an S instruction, the method will proceed to step 50 in which an ALU operation will be carried out on the two data words to produce an outcome data word. In step 51, a mirror data word is generated. At step 62, the predetermined static bit of the outcome data word is written to the corresponding bit position in the mirror data words. At step 53, the remainder of the mirror data words, excluding the static bit, is separated into an upper portion and a lower portion. At step 64, the outcome data word, excluding the static bit, is separated into an upper portion and a lower portion. At step 55, the outcome data word's upper portion is written to the mirror data word's lower portion and the outcome data word's lower portion is written to the mirror data word's upper portion. Finally, at step 56, the mirror data word is substituted for the outcome data word as the result data word.

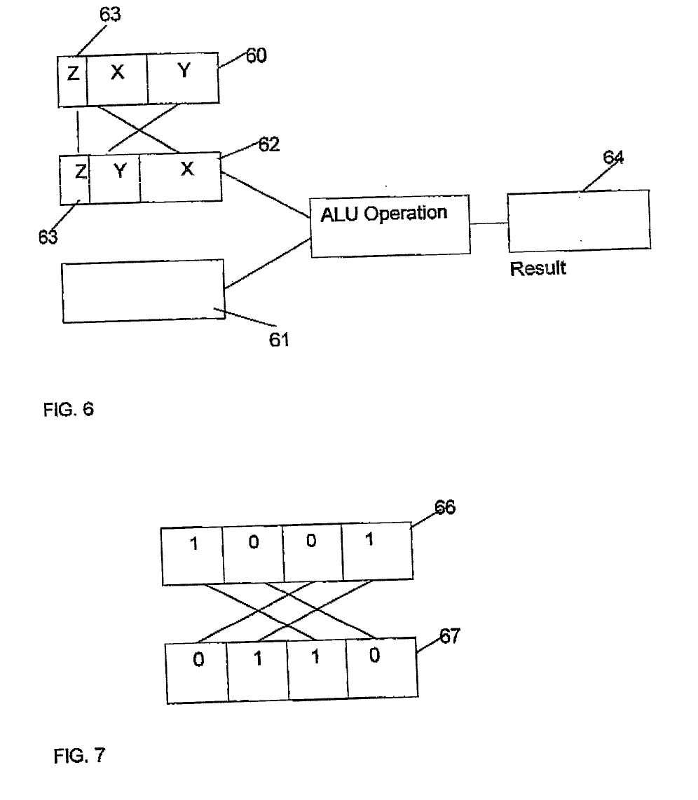

Referring now to FIG. 6, there is shown a block diagram of an X instruction carried out according to the method outlined In FIG. 4. In this case, two operands 60, 61 are retrieved in the normal manner. A mirror data word 62 is generated The predetermined static bit 63 of the data word 50 is written directly to the corresponding bit position 65 In the mirror data word 62. In this case, the MSB is shown as the static bit but equally well, it could be any chosen bit. The remainder of the mirror data word 62, excluding the static bit 65, Is separated into an upper portion and a lower portion. The remainder of the data word 60, excluding the static bit 63 is separated into an upper portion and a lower portion. The upper portion of the data word 60 is written to the lower portion of the mirror data word 62 and the lower portion of the data word 60 is written to the upper portion of the mirror data word 62. The mirror data word 62 is substituted for the data word 60 for the purpose of further calculations and the ALU operation is then carried out on the data word 61 and the now switched original data word to produce a result data word 64. The S instruction is carried out in a manner as previously described and it is not deemed necessary to show an S instruction for the current method.

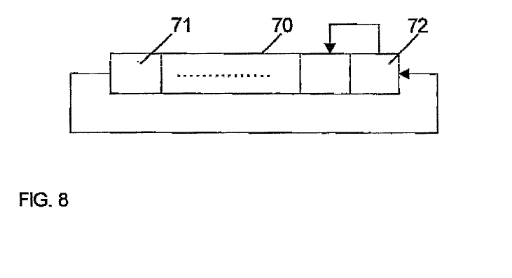

FIG. 7 shows an example of cross-wiring techniques. In this example shown, we have a data word indicated by the reference numeral 66. This data word contains a total of four bits and is separated into an upper portion and a lower portion, the upper portion containing bit 3 and bit 2 and the lower portion containing bit 1 and bit 0. There is also provided a mirror data word 67, also having a total of four bits separated into an upper portion [bit 3 and bit 2] and a lower portion [bit 1 and bit 0]. The upper portion of the data word 66 is directly wired to the lower portion of the mirror data word 67, i.e. bit 3 and bit 2 of the data word to bit 1 and bit 0 respectively of the mirror data word 67 and the lower portion of the data word 66 is directly wired to the upper portion of the mirror data word 67, i.e. bit 1 and bit 0 of the data word 66 to bit 3 and bit 2 respectively of the mirror data word 67. When a data word is loaded into the data word position 66, it will be automatically and practically instantaneously be written to the mirror data word 67 in a rearranged format. For example, if the bit sequence 1001 was written to data word position 66, the sequence ‘0110’ would appear on the mirror data word. Due to the fact that this may be done in hardware, it is practically instantaneous and it enables us to speed up the processing speed and reduce the time it takes to execute an operation requiring such swapping.

FIG. 8 shows an example of a single rotational shift left operation. There is provided a data word, indicated generally by the reference numeral 70, having an MSB 71 and an LSB 72. When the processor is to perform a single rotational shift left operation, it takes the MSB from the end of the data word 70 and shifts the entire data up one position to the left. Once the shift operation has been completed, the MSB is placed in the now vacant LSB position. As explained, a rotational shift operation may involve shifting several bit positions at the same time. This is achieved by using extensive logic gate circuitry (not shown) and a person well versed in the art would be able to reproduce such logic circuitry. By implementing the invention by using a rotational shift operation, the designer does not have to produce a separate mirror word as such. The logic circuitry and the data word work in conjunction with each other to perform the duties of a mirror data word. The logic circuitry temporarily holds the data of one half of the word while the appropriate shift operations are carried out until it can be placed back into the data word. The data word will then be ready for further calculations or operations as desired. This logic circuitry may be combined with additional circuitry to perform the ALU operation of the data word thereby using only one instruction. This, as explained, is of substantial benefit to the designer and the ultimate user of such a method.

The processor described may not have been realised in silicon yet and may be in its design layout form in which case it may be embodied in a computer program. This program may be stored on a carrier, for example, a computer readable medium or a carrier signal.

It must be appreciated that throughout the specification, the MSB has been taken to mean the leftmost bit while the LSB has been taken to mean the rightmost bit in a piece of data. Accordingly, the data adjacent the MSB has been named as the upper portion and the data adjacent the LSB has been named the lower portion, it is understood that the data may be arranged having the MSB on the right-hand side of a piece of data and the LSB on the lent-hand side and references to the upper and lower portions should be construed accordingly.

Some of the embodiments of the invention described with reference to the drawings comprise processes that may be performed in computer apparatus. The invention also extends to computer programs, particularly computer programs on or in a carder adapted for putting the invention into practice. The code may be in source code, object code, or a code intermediate source and object code or any other form suitable for use in the implementation of the methods according to the invention.

The carrier may comprise a storage medium, for example, a ROM, CD or semiconductor, floppy disk or any other recording medium. Alternatively, the carrier may be a transmissible carrier such as an electrical or an optical or radio signal which may be conveyed by an electrical or optical cable or any other means. When the program is embodied in a signal or such cables or other means, the carrier may be constituted by such means.

The carrier may also be an integrated circuit in which the program is embedded, the integrated circuit being adapted for performing or for use in the performance of relevant methods.

In the specification the terms “comprise, comprises, comprised and comprising” or any variation thereof and the terms “include, includes, included and including” or any variation thereof are considered to be totally interchangeable and they should all be afforded the widest possible interpretation and vice versa.

The invention is not limited to the embodiments hereinbefore described but may be varied in both construction and detail within the scope of the claims.

1. A method of processing two data words to provide a new data word in a processor comprising an arithmetic logic unit (ALU), a plurality of registers and access to memory, the method comprising, not necessarily in this order, the steps of:
(a) using the ALU to perform an operation on the data words, each being of n-bit size, to form another data word of n-bit size; and
(b) performing a switching operation on one of the data words by separating the data word into discrete portions and rearranging the order of portions.

2. A method of processing two data words to provide a new data word as claimed in claim 1, in which the switching operation further comprises the steps of:
(c) separating the data word into an upper portion and a lower portion;
(d) generating a mirror data word of p-bit size, where p=n;
(e) separating the mirror data word into an upper portion and a lower portion where the upper portion of the mirror data word is equal in size to the lower portion of the data word and the lower portion of the mirror data word is equal in size to the upper portion of the data word;
(f) copying the data in the upper portion of the data word into the lower portion of the mirror data word and copying the data in the lower portion of the data word into the upper portion of the mirror data word; and
(g) substituting the data word with the mirror data word.

3. A method of processing two data words to provide a new data word as claimed in claim 2, in which when n is an even number, the data word's upper portion comprises bit (n−1) to bit (n/2) and its lower portion comprises bit [(n/2)−1] to bit 0 and the mirror data word's upper portion comprises bit (p−1) to bit (p/2) and it's lower portion comprises bit [(p/2)−1] to bit 0.

4. A method of processing two data words to provide a new data word as claimed in claim 2, in which when n is an uneven number, the data word's upper portion comprises bit (n−1) to bit [(n−1)/2] and it's lower portion comprises bit {[(n−1)/2]−1} to bit 0 and the mirror data word's upper portion comprises bit (p−1) to bit [(p+1)/2] and it's lower portion comprises bit [(p−1)/2] to bit 0.

5. A method of processing two data words to provide a new data word as claimed in claim 2, in which when n is an uneven number, the data words upper portion comprises bit (n−1) to bit [(n+1)/2] and its lower portion comprises bit [(n−1)/2] to bit 0 and the mirror data words upper portion comprises bit (p−1) to bit [(p−1)/2] and its lower portion comprises bit {[(p−1)/2]−1} to bit 0.

6. A method of processing two data words to provide a new data word as claimed in claim 2 in which when n is an uneven number, subsequent to generating a mirror data word of p-bit size where p=n, the additional intermediate step is performed of:
(h) designating a particular bit of the data word to act as a static bit, copying the static bit to the corresponding position in the mirror data word; and thereafter performing the separation and copying steps on the remainder of the bits of the data word and the mirror data word.

7. A method of processing two data words to provide a new data word as claimed in claim 2, in which the switching operation performed on one of the data words is performed by using cross-wiring techniques.

8. A method of processing two data words to provide a new data word as claimed in claim 2, in which the switching operation is performed on one of the data words using logic circuitry.

9. A method of processing two data words to provide a new data word as claimed in claim 2, in which the switching operation is performed on one of the data words before an ALU operation is performed on that data word and another data word.

10. A method of processing two data words to provide a new data word as claimed in claim 2, in which the ALU operation is performed on the two data words to produce another data word and then a switching operation is performed on the other data word.

11. A method of processing two data words to provide a new data word as claimed in claim 1, in which the switching operation performed on one of the data words is performed by using cross-wiring techniques.

12. A method of processing two data words to provide a new data word as claimed in claim 1, in which the switching operation is performed on one of the data words using logic circuitry.

13. A method of processing two data words to provide a new data word as claimed in claim 1, in which the switching operation is performed on one of the data words before an ALU operation is performed on that data word and another data word.

14. A method of processing two data words to provide a new data word as claimed in claim 1, in which the ALU operation is performed on the two data words to produce another data word and then a switching operation is performed on the other data word.

15. A method of processing two data words to provide a new data word in a processor comprising an arithmetic logic unit (ALU), a plurality of registers and access to memory, the method comprising, not necessarily in this order, the steps of:
(a) using the ALU to perform an operation on the data words, each being of n-bit size, to form another data word of n-bit size;
(b) performing a switching operation on one of the data words further comprising the steps of:
(c) separating the data word into an upper portion and a lower portion;
(d) generating a mirror data word of p-bit size, where p=n;
(e) separating the mirror data word into an upper portion and a lower portion where the upper portion of the mirror data word is equal in size to the lower portion of the data word and the lower portion of the mirror data word is equal in size to the upper portion of the data word;
(f) copying the data in the upper portion of the data word into the lower portion of the mirror data word and copying the data in the lower portion of the data word into the upper portion of the mirror data word; and
(g) substituting the data word with the mirror data word.

16. A method of processing two data words to provide a new data word as claimed in claim 15, in which when n is an even number, the data word's upper portion comprises bit (n−1) to bit (n/2) and it's lower portion comprises bit [(n/2)−1] to bit 0 and the mirror data word's upper portion comprises bit (p−1) to bit (p/2) and it's lower portion comprises bit [(p/2)−1] to bit 0.

17. A method of processing two data words to provide a new data word as claimed in claim 15, in which when n is an uneven number, the data word's upper portion comprises bit (n−1) to bit [(n−1)/2] and its lower portion comprises bit {[(n−1)/2]−1} to bit 0 and the mirror data word's upper portion comprises bit (p−1) to bit [(p+1)/2] and it's lower portion comprises bit [(p−1)/2] to bit 0.

18. A method of processing two data words to provide a new data word as claimed in claim 15, in which when n is an uneven number, the data words upper portion comprises bit (n−1) to bit [(n+1)/2] and its lower portion comprises bit [(n−1)/2] to bit 0 and the mirror data words upper portion comprises bit (p−1) to bit [(p−1)/2] and its lower portion comprises bit {[(p−1)/2]−1} to bit 0.

19. A method of processing two data words to provide a new data word as claimed in claim 15 in which when n is an uneven number, subsequent to generating a mirror data word of p-bit size where p=n, the additional intermediate step is performed of:
(h) designating a particular bit of the data word to act as a static bit, copying the static bit to the corresponding position in the mirror data word; and thereafter performing the separation and copying steps on the remainder of the bits of the data word and the mirror data word.

20. A method of processing two data words to provide a new data word as claimed in claim 15, in which the switching operation performed on one of the data words is performed by using cross-wiring techniques.

21. A method of processing two data words to provide a new data word as claimed in claim 15, in which the switching operation is performed on one of the data words using logic circuitry.

22. A method of processing two data words to provide a new data word as claimed in claim 15, in which the switching operation is preformed on one of the data words before an ALU operation is performed on that data word and another data word.

23. A method of processing two data words to provide a new data word as claimed in claim 15, in which the ALU operation is performed on the two data words to produce another data word and then a switching operation is performed on the other data word.

24. A method of processing two data words to provide a new data word in a processor comprising an ALU, a plurality of registers and access to memory, the method comprising, not necessary in this order, the steps of:
(a) using the ALU to perform an operation on the data words, each being of n-bit size, to form another data word of n-bit size; and
(b) performing a switching operation on one of the data words in which the data word is separated into discrete portions and the order of the portions is rearranged by using cross wiring techniques, the cross-wiring techniques further comprising the step of:
(c) delivering the data word from a start location to an end location along a pathway in which the wires of the pathway have been cross-wired so that the individual bits of the data word may be rearranged into a desired configuration before arriving at the end location.

25. A method of processing two data words as claimed in claim 24, in which the end location of the data word is the ALU and the ALU operation is carried out after the switching operation is performed.

26. A method of processing two data words as claimed in claim 24 in which the ALU operation is performed before the switching operation is carried out and the start location of the data word is the result of the ALU operation.

27. A method of processing two data words, each having a plurality of bits to provide a new data word in a processor, the processor comprising an ALU, a plurality of registers and access to memory, the method comprising the steps of:
(a) retrieving the data words from the registers;
(b) passing one of the data words directly to the ALU;
(c) passing the other data word to the ALU along a cross-wired pathway in which the individual bits of the data words may be rearranged into a desired configuration before arriving at the ALU; and
(d) performing an ALU operation on the two data words.

28. A method of processing two data words to provide a new data word in a processor, the processor comprising an ALU, a plurality of registers and access to memory, the method comprising the steps of:
(a) retrieving the data words from the registers;
(b) passing the data words to the ALU and performing an ALU operation thereupon;
(c) delivering the result of the ALU operation to a desired location along a cross-wired path in which the individual bits of the data word may be rearranged into a desired configuration before reaching the desired location.

29. A data processor comprising an ALU, a plurality of registers and access to memory characterised in that the data processor comprises means to execute an instruction on two data words to provide a new data word, the means to execute an instruction comprising:
(a) means to perform an ALU operation on data words, each being of n-bit size, to form another data word, also of n-bit size; and
(b) means to perform a switching operation on one of the data words by separating the data word into discrete portions and rearranging the order of portions.

30. A data processor as claimed in claim 29, in which the means to perform the switching operation further comprises:
(c) means to separate the data word into an upper portion and a lower portion;
(d) means to generate a mirror data word of p-bit size, where p=n;
(e) means to separate the mirror data word into an upper portion and a lower portion where the upper portion of the mirror data word is equal in size to the lower portion of the data word and the lower portion of the mirror data word is equal in size to the upper portion of the data word;
(f) means to copy the data in the upper portion of the data word into the lower portion of the mirror data word and copy the data in the lower portion of the data word into the upper portion of the mirror data word; and
(g) means to substitute the data word with the mirror data word.

31. A data processor as claimed in claim 30, in which when n is an even number, the data word's upper portion comprises bit (n−1) to bit (n/2) and it's lower portion comprises bit [(n/2)−1] to bit 0 and the mirror data word's upper portion comprises bit (p−1) to bit (p/2) and it's lower portion comprises bit [(p/2)−1] to bit 0.

32. A data processor as claimed in claim 30, in which when n is an uneven number, the data word's upper portion comprises bit (n−1) to bit [(n−1)/2] and it's lower portion comprises bit {[(n−1)/2]−1} to bit 0 and the mirror data word's upper portion comprises bit (p−1) to bit [(p+1)/2] and it's lower portion comprises bit [(p−1)/2] to bit 0.

33. A data processor as claimed in claim 30, in which when n is an uneven number, the data words upper portion comprises bit (n−1) to bit [(n+1)/2] and its lower portion comprises bit [(n−1)/2] to bit 0 and the mirror data words upper portion comprises bit (p−1) to bit [(p−1)/2] and its lower portion comprises bit {[(p−1)/2]−1} to bit 0.

34. A data processor as claimed in claim 30, in which when n is an uneven number, subsequent to the generation of a mirror data word of p-bit size where p=n, the data processor further comprises:
(h) means to designate a particular bit of the data word to act as a static bit and to copy the static bit to the corresponding position in the mirror data word; and thereafter performing the separation and copying steps on the remainder of the bits of the data word and the mirror data word.

35. A data processor as claimed in claim 30, in which the means to perform the switching operation on one of the data words comprises cross-wiring techniques.

36. A data processor as claimed in claim 30, in which the means to perform the switching operation on one of the data words comprises logic circuitry.

37. A data processor as claimed in claim 30, in which the processor comprises means to execute an instruction in which the switching operation on one of the data words is carried out before an ALU operation is performed on that data word and another data word.

38. A data processor as claimed in claim 30, in which the processor comprises means to execute an instruction in which the ALU operation is performed on the two data words to produce another data word and then a switching operation is carried out on that other data word.

39. A data processor as claimed in claim 30 in which the processor is embodied in a software program.

40. A data processor as claimed in claim 39, in which the processor embodied in a software program is stored on a record medium.

41. A data processor as claimed in claim 39, in which the processor embodied in a software program is stored on a carrier signal.

42. A data processor as claimed in claim 29, in which the means to perform the switching operation on one of the data words comprises cross-wiring techniques.

43. A data processor as claimed in claim 29, in which the means to perform the switching operation on one of the data words comprises logic circuitry.

44. A data processor as claimed in claim 29, in which the processor comprises means to execute an instruction in which the switching operation on one of the data words is carried out before an ALU operation is performed on that data word and another data word.

45. A data processor as claimed in claim 29, in which the processor comprises means to execute an instruction in which the ALU operation is performed on the two data words to produce another data word and then a switching operation is carried out on that other data word.

46. A data processor as claimed in claim 29, in which the processor is embodied in a software program.

47. A data processor as claimed in claim 46, in which the processor embodied in a software program is stored on a record medium.

48. A data processor as claimed in claim 29, in which the processor embodied in a software program is stored on a carrier signal.

49. A data processor comprising an ALU, a plurality of registers and access to memory, the data processor comprising means to execute an instruction on two data words to provide a new data word, the means to execute an instruction comprising:
(a) means to perform an ALU operation on data words, each being of n-bit size, to form another data word, also of n-bit size; and
(b) means to perform a switching operation on one of the data words which further comprises:
(c) means to separate the data word into an upper portion and a lower portion;
(d) means to generate a mirror data word of p-bit size, where p=n;
(e) means to separate the mirror data word into an upper portion and a lower portion where the upper portion of the mirror data word is equal in size to the lower portion of the data word and the lower portion of the mirror data word is equal in size to the upper portion of the data word;
(f) means to copy the data in the upper portion of the data word into the lower portion of the mirror data word and copy the data in the lower portion of the data word into the upper portion of the mirror data word; and
(g) means to substitute the data word with the mirror data word.

50. A data processor as claimed in claim 49, in which when n is an even number, the data word's upper portion comprises bit (n−1) to bit (n/2) and it's lower portion comprises bit [(n/2)−1] to bit 0 and the mirror data word's upper portion comprises bit (p−1) to bit (p/2) and its lower portion comprises bit [(p/2)−1] to bit 0.

51. A data processor as claimed in claim 49, in which when n is an uneven number, the data words upper portion comprises bit (n−1) to bit [(n−1)/2] and its lower portion comprises bit {[(n−1)/2]−1} to bit 0 and the mirror data words upper portion comprises bit (p−1) to bit [(p+1)/2] and its lower portion comprises bit [(p−1)/2] to bit 0.

52. A data processor as claimed in claim 49, in which when n is an uneven number, the data words upper portion comprises bit (n−1) to bit (n+1)/2] and its lower portion comprises bit [(n−1)/2] to bit 0 and the mirror data words upper portion comprises bit (p−1) to bit [(p−1)/2] and its lower portion comprises bit {[(p−1)/2]−1} to bit 0.

53. A data processor as claimed in claim 49, in which when n is an uneven number, subsequent to the generation of a mirror data word of p-bit size where p=n, the data processor further comprises:
(h) means to designate a particular bit of the data word to act as a static bit and to copy the static bit to the corresponding position in the mirror data word; and thereafter performing the separation and copying steps on the remainder of the bits of the data word and the mirror data word.

54. A data processor as claimed in claim 49, in which the means to perform the switching operation on one of the data words comprises cross-wiring techniques.

55. A data processor as claimed in claim 49, in which the means to perform the switching operation on one of the data words comprises logic circuitry.

56. A data processor as claimed in claim 49, in which the processor comprises means to execute an instruction in which the switching operation on one of the data words is carried out before an ALU operation is performed on that data word and another data word.

57. A data processor as claimed in claim 49, in which the processor comprises means to execute an instruction in which the ALU operation is performed on the two data words to produce another data word and then a switching operation is carried out on that other data word.

58. A data processor as claimed in claim 49 in which the processor is embodied in a software program.

59. A data processor as claimed in claim 58, in which the processor embodied in a software program is stored on a record medium.

60. A data processor as claimed in claim 58, in which the processor embodied in a software program is stored on a carrier signal.

61. A data processor comprising an ALU, a plurality of registers and access to memory, the data processor comprising means to execute an instruction on two data words to provide a new data word, the means to execute an instruction comprising:
(a) means to perform an ALU operation on the data words, each being of n-bit size, to form another data word also of n-bit size;
(b) means to perform a switching operation on one of the data words in which the data word is separated into discrete portions and the order of the portions is rearranged by cross-wiring means, the cross-wiring means comprising:
(c) a wiring pathway between a start location and an end location in which the wires of the pathway have been cross-wired so that the individual bits of the data word may be rearranged into a desired configuration before arriving at the end location.

62. A data processor as claimed in claim 61, in which the end location of the wiring pathway is the means to perform an ALU operation so that a data word has undergone a switching operation before the ALU operation.

63. A data processor as claimed in claim 61 in which the start location of the wiring pathway is an output of the means to perform an ALU operation so that a data word has undergone an ALU operation before a switching operation.

64. A data processor comprising an ALU, a plurality of registers and access to memory, the data processor comprising means to execute an instruction on two data words to provide a new data word, the means to execute an instruction comprising:
(a) means to retrieve the data words from the registers;
(b) means to pass one of the data words directly to the ALU;
(c) means to deliver the other data word to the ALU along a cross-wired pathway in which the individual bits of the data word may be rearranged into a desired configuration before arriving at the ALU; and
(d) means to perform an ALU operation on the two data words.

65. A data processor comprising an ALU, a plurality of registers and access to memory, the data processor comprising means to execute an instruction on two data words to provide a new data word, the means to execute an instruction comprising:
(a) means to retrieve the data words from the registers and to pass the data words to the ALU;
(b) means to perform an ALU operation on the data words to produce a result data word;
(c) means to deliver the result data word to a desired location along a cross-wired path in which the individual bits of the result data word may be rearranged into a desired configuration before reaching the desired location.

66. A computer program comprising program instructions for causing a computer to perform the method of claim 1.

67. A computer program comprising program instructions for causing a computer to perform the method of claim 2.

68. A computer program comprising program instructions for causing a computer to perform the method of claim 15.

69. A computer program comprising program instructions for causing a computer to perform the method of claim 24.

70. A computer program comprising program instructions for causing a computer to perform the method of claim 27.

71. A computer program comprising program instructions for causing a computer to perform the method of claim 28.

72. A computer program as claimed in claim 66 in which the program is stored on a computer readable medium.

73. A computer program as claimed in claim 67 in which be program is stored on a computer readable medium.

74. A computer program as claimed in claim 68 in which the program is stored on a computer readable medium.

75. A computer program as claimed in claim 69 in which the program is stored on a computer readable medium.

76. A computer program as claimed in claim 70 in which the program is stored on a computer readable medium.

77. A computer program as claimed in claim 71 in which the program is stored on a computer readable medium.

78. A computer program as claimed in claim 66 in which program is stored on a carrier signal.

79. A computer program as claimed in claim 67 in which program is stored on a carrier signal.

80. A computer program as claimed in claim 68 in which program is stored on a carrier signal.

81. A computer program as claimed in claim 69 in which program is stored on a carrier signal.

82. A computer program as claimed in claim 70 in which program is stored on a carrier signal.

83. A computer program as claimed in claim 71 in which program is stored on a carrier signal.

84. A computer program as claimed in claim 66 in which the program is stored in a computer memory.

85. A computer program as claimed in claim 67 in which the program is stored in a computer memory.

86. A computer program as claimed in claim 68 in which the program is stored in a computer memory.

87. A computer program as claimed in claim 69 in which the program is stored in a computer memory.

88. A computer program as claimed in claim 70 in which the program is stored in a computer memory.

89. A computer program as claimed in claim 71 in which the program is stored in a computer memory.

90. A computer program as claimed in claim 66 in which the program is embedded in an integrated circuit.

91. A computer program as claimed in claim 67 in which the program is embedded in an integrated circuit.

92. A computer program as claimed in claim 68 in which the program is embedded in an integrated circuit.

93. A computer program as claimed in claim 69 in which the program is embedded in an integrated circuit.

94. A computer program as claimed in claim 70 in which the program is embedded in an integrated circuit.

95. A computer program as claimed in claim 71 in which the program is embedded in an integrated circuit.

96. A computer programmed to carry out the method claimed in claim 1.

97. A computer programmed to carry out the method claimed in claim 2.

98. A computer programmed to carry out the method of claim 15.

99. A computer programmed to carry out the method of claim 24.

100. A computer programmed to carry out the method of claim 27.

101. A computer programmed to carry out the method of claim 28.
